(19) United States
(12) Patent Application Publication
(10) Pub. No.: US 2025/0351156 A1
(43) Pub. Date: Nov. 13, 2025

(54) METHODS, DEVICES, AND SYSTEMS FOR RESOURCE DETERMINATION MECHANISM WITH MULTI-CELL DCI

(71) Applicant: ZTE Corporation, Shenzhen (CN)

(72) Inventors: Jing SHI, Shenzhen (CN); Xianghui HAN, Shenzhen (CN); Shuaihua KOU, Shenzhen (CN); Xingguang WEI, Shenzhen (CN)

(21) Appl. No.: 19/223,688

(22) Filed: May 30, 2025

Related U.S. Application Data
(63) Continuation of application No. PCT/CN2023/076562, filed on Feb. 16, 2023.

(51) Int. Cl. H04W 72/232; H04L 5/00; H04W 72/1263

(52) U.S. Cl. CPC H04W 72/232; H04L 5/001; H04W 72/1263

(57) ABSTRACT

The present disclosure describes methods, system, and devices for resource determination mechanism with a multi-cell scheduling downlink control information (MC-DCI). One method includes receiving a configuration including a value for a first set of cells, a first user-specific search space (USS) of a multi-cell scheduling downlink control information (MC-DCI) on a scheduling cell, a second USS on a scheduled cell associated with the first USS; and determining resource of the first and second USS on the scheduling cell.

### CROSS REFERENCE TO RELATED APPLICATIONS

This patent document is a continuation of and claims benefit of priority to International Patent Application No. PCT/CN2023/076562, filed on Feb. 16, 2023. The entire content of the before-mentioned patent application is incorporated by reference as part of the disclosure of this application.

### TECHNICAL FIELD

The present disclosure is directed generally to wireless communications. Particularly, the present disclosure relates to methods, devices, and systems for resource determination mechanism with a multi-cell scheduling downlink control information (MC-DCI).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Carrier aggregation (CA) is used to improve the performance of wireless communication system in 4G and 5G and further communication system. CA may increase data rate per user equipment (UE) by assigning multiple component carriers in the frequency domain to a same UE. In some implementations of employing CA, scheduling mechanism may only allow scheduling of single cell physical uplink shared channel (PUSCH) and/or physical downlink shared channel (PDSCH) per a scheduling downlink control information (DCI). With more available scattered spectrum bands, the need of simultaneous scheduling of multiple cells is expected to be increasing. To reduce the control overhead, it is beneficial to extend from single-cell scheduling to multi-cell PUSCH/PDSCH scheduling with a single scheduling DCI. There are various problems/issues associated some schemes. For example, when both scheduling cell and one scheduled cell configured with user specific search space (USS) of DCI format 0_X/1_X, how to derive the USS of DCI format 0_X/1_X based on the n_CI for the set of cells; and for another example, how to count the candidates for the reference cell.

The present disclosure describes various embodiments for resource determination mechanism with a multi-cell scheduling downlink control information (MC-DCI), addressing at least one of the issues/problems discussed in the present disclosure.

### SUMMARY

This document relates to methods, systems, and devices for wireless communication, and more specifically, for resource determination mechanism with a multi-cell scheduling downlink control information (MC-DCI).

In one embodiment, the present disclosure describes a method for wireless communication. The method may be performed by a wireless communication device (e.g., a user equipment). The method includes receiving a configuration including a value for a first set of cells, a first user-specific search space (USS) of a multi-cell scheduling downlink control information (MC-DCI) on a scheduling cell, a second USS on a scheduled cell associated with the first USS; and determining resource of the first and second USS on the scheduling cell.

In one embodiment, the present disclosure describes another method for wireless communication. The method may be performed by a wireless communication node (e.g., a base station or a radio access network (RAN)). The method includes sending a configuration including a value for a first set of cells, a first user-specific search space (USS) of a multi-cell scheduling downlink control information (MC-DCI) on a scheduling cell, a second USS on a scheduled cell associated with the first USS, so that upon receiving the configuration, a wireless communication device is configured to determine resource of the first and second USS on the scheduling cell.

In one embodiment, the present disclosure describes another method for wireless communication. The method may be performed by a wireless communication device (e.g., a user equipment). The method includes: receiving a configuration of a search space of a multi-cell scheduling downlink control information (MC-DCI) for at least one set of cells, wherein: the at least one set of cells is configured for multi-cell scheduling, and at least one cell of the at least one set of cells is scheduled by the MC-DCI on a physical downlink control channel (PDCCH) candidate on a scheduling cell; and in response to the MC-DCI comprising a specific field, applying a set of specific functions based on the specific field.

In one embodiment, the present disclosure describes another method for wireless communication. The method may be performed by a wireless communication node (e.g., a base station or a radio access network (RAN)). The method includes sending a configuration of a search space of a multi-cell scheduling downlink control information (MC-DCI) for at least one set of cells, wherein: the at least one set of cells is configured for multi-cell scheduling, at least one cell of the at least one set of cells is scheduled by the MC-DCI on a physical downlink control channel (PDCCH) candidate on a scheduling cell, and a wireless communication device, upon receiving the configuration and in response to the MC-DCI comprising a specific field, is configured to apply a set of specific functions based on the specific field.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims

### BRIEF DESCRIPTION OF THE DRAWINGS

FIG. 1A shows an example of a wireless communication system include one wireless network node and one or more user equipment.

FIG. 1B shows a schematic diagram of an exemplary embodiment for wireless communication.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 4C shows a flow diagram of another method for wireless communication.

FIG. 4D shows a flow diagram of another method for wireless communication.

FIG. 5A shows a schematic diagram of an exemplary embodiment for wireless communication.

FIG. 5B shows a schematic diagram of another exemplary embodiment for wireless communication.

FIG. 6 shows a schematic diagram of another exemplary embodiment for wireless communication.

FIG. 7 shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for resource determination mechanism with a multi-cell scheduling downlink control information (MC-DCI).

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC).

Carrier aggregation (CA) is used to improve the performance of wireless communication system in 4G and 5G and further communication system. CA may increase data rate per user equipment (UE) by assigning multiple component carriers in the frequency domain to a same UE. In some implementations of employing CA, scheduling mechanism may only allow scheduling of single cell physical uplink shared channel (PUSCH) and/or physical downlink shared channel (PDSCH) per a scheduling downlink control information (DCI). With more available scattered spectrum bands, the need of simultaneous scheduling of multiple cells is expected to be increasing. To reduce the control overhead, it is beneficial to extend from single-cell scheduling to multi-cell PUSCH/PDSCH scheduling with a single scheduling DCI.

When multi-cell scheduling with a single scheduling DCI format (e.g., format 0_X and/or 1_X) are introduced for a set of cells, a DCI size of the DCI format 0_X/1_X is counted on one cell among the set of cells, a blind decode and/or control channel element (BD/CCE) of the DCI format 0_X/1_X is counted on one cell among the set of cells. Search space (SS) of the DCI format 0_X/1_X is configured on one cell of the set of cells and associated with the search space of the scheduling cell with the same search space identifier (ID). For monitoring PDCCH candidates for a set of cells which is configured for multi-cell scheduling, a value of n_CI in the search space equation is determined by a value configured for the set of cells. There are various problems/issues associated some schemes. For example, when both scheduling cell and one scheduled cell configured with user specific search space (USS) of DCI format 0_X/1_X, how to derive the USS of DCI format 0_X/1_X based on the n_CI for the set of cells; and for another example, how to count the candidates for the reference cell.

The various embodiments and implementations described in the present disclosure include methods and devices for resource determination mechanism with a multi-cell scheduling downlink control information (MC-DCI), addressing at least one of the issues/problems discussed in the present disclosure.

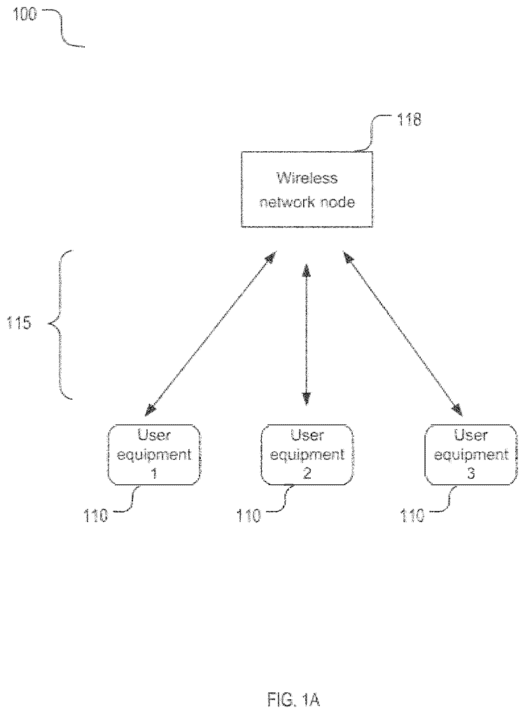

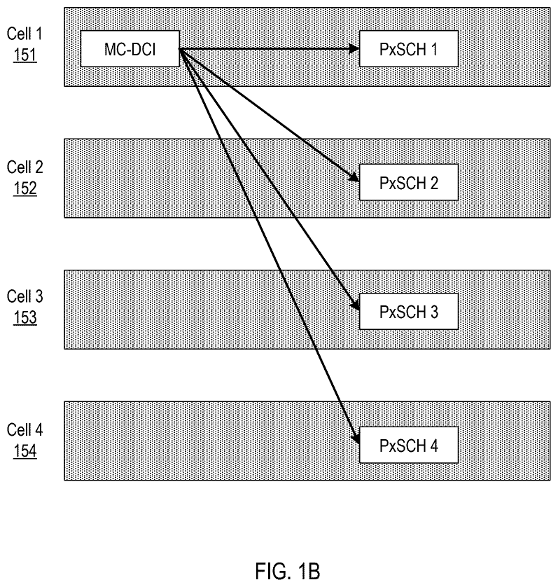

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

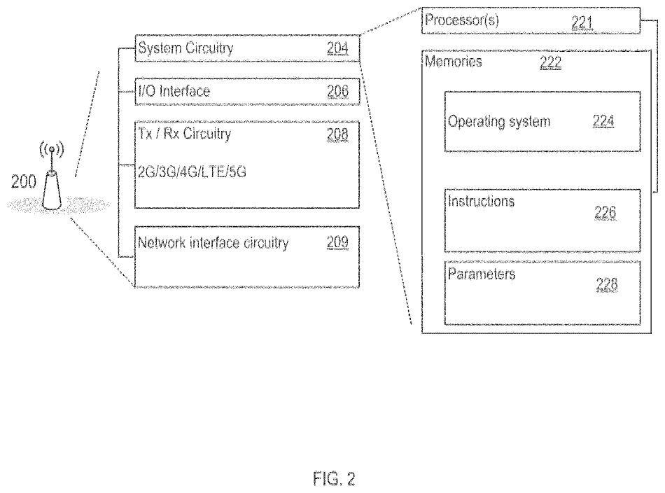

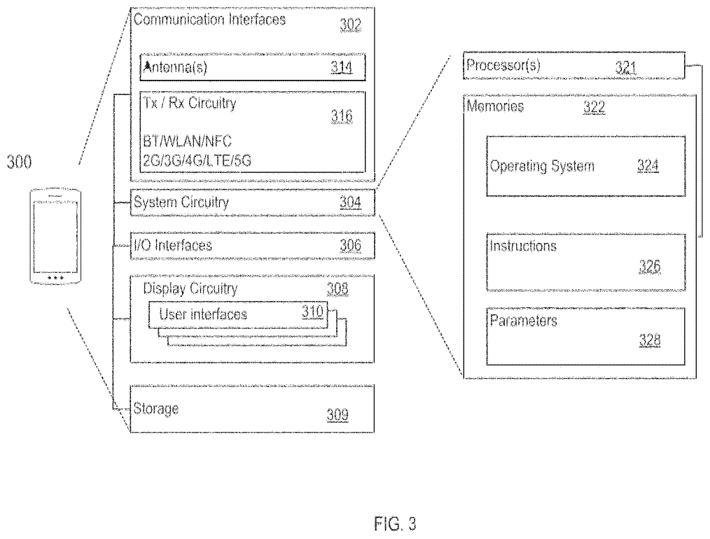

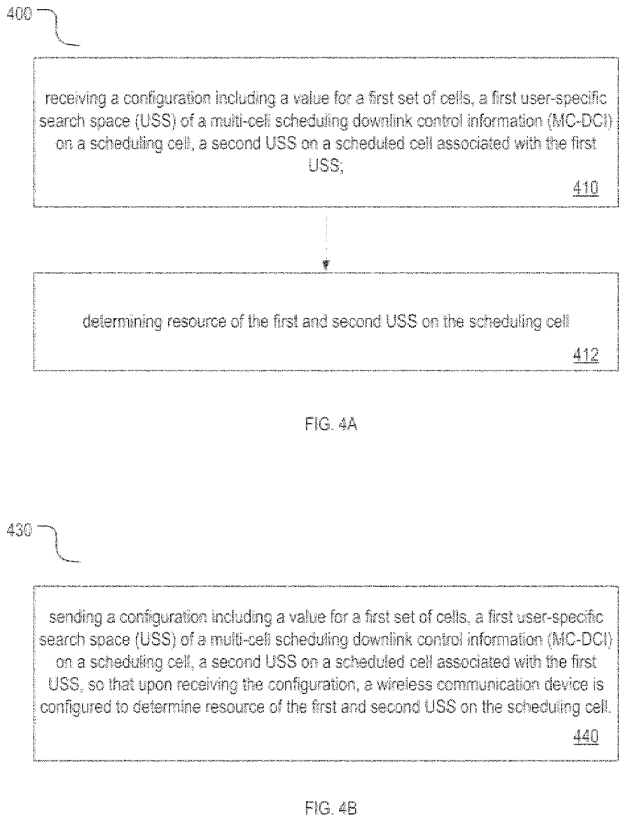

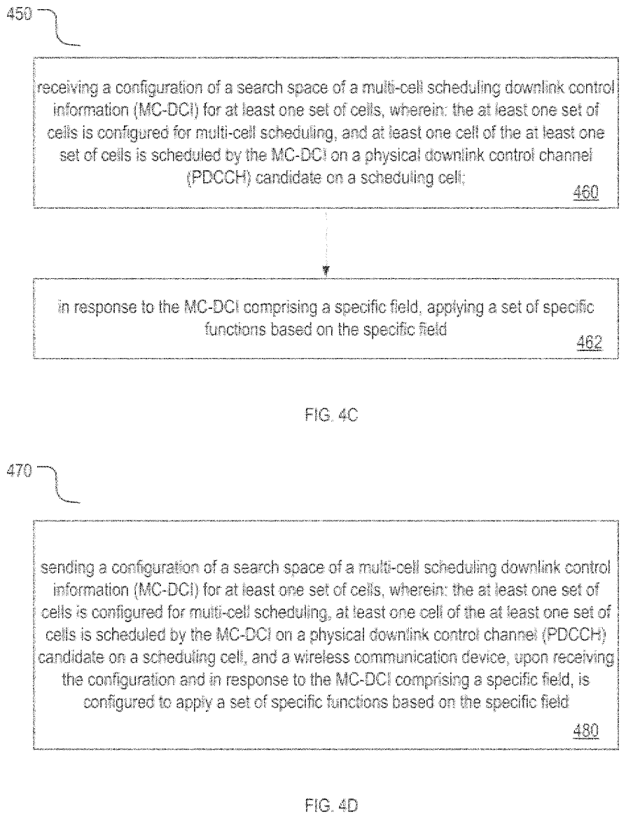

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for resource determination mechanism with a multi-cell scheduling downlink control information (MC-DCI), which may be implemented, partly or totally, on the network base station and/or the user equipment described above in FIGS. 2-3. The various embodiments in the present disclosure may enable efficient wireless transmission in the telecommunication system, which may increase the resource utilization efficiency and/or boost latency performance of URLLC traffic.

In some implementations for multi-cell scheduling, under a normal situation, one scheduled cell may be only configured with single scheduling cell. FIG. 1B shows a multi-cell scheduling, wherein a first cell (Cell 1, 151) may be a scheduling cell, a second cell (Cell 2, 152) may be a scheduled cell, a third cell (Cell 3, 153) may be another scheduled cell, and a fourth cell (Cell 4, 154) may be another scheduled cell. A scheduled cell may be only configured with one scheduling cell and a single multi-cell scheduling DCI (MC-DCI), which may be a DCI format 0_X/1_X and carried by PDCCH, may be used to schedule multi-PxSCH on multi cells, with each PxSCH on one cell. The term “PxSCH” may be used to refer to either a physical downlink shared channel (PDSCH) or a physical uplink shared channel (PUSCH). In some implementations, the PDCCH may be called as a control channel, and the PxSCH may be called as a data channel.

As shown in FIG. 1B, there is only one scheduling cell for a scheduled cell, and MC-DCI and/or single cell scheduling DCI (SC-DCI), which is a legacy DCI forma (e.g. DCI format 0_1/1_1), may be supported on the scheduling cell for a scheduled cell. MC-DCI may be a new DCI format 0_X/1_X.

In some implementations, for example in a normal case, a DCI size and/or blind decode/control channel element (BD/CCE) of the PDCCH carried the multi-cell scheduling DCI are counted on one cell among the set of cells. In some implementations, the BD is corresponding to the Maximum number

$${M}_{PDCCH}^{max , slot , μ}$$

of monitored PDCCH candidates per slot/span for a downlink (DL) bandwidth part (BWP) with a subcarrier spacing (SCS) configuration μ∈{0, 1,2,3} for a single serving cell. The CCE is corresponding to the maximum number

$${C}_{PDCCH}^{max , slot , μ}$$

of non-overlapped CCEs per slot/span for a DL BWP with SCS configuration μ∈{0, 1,2,3} for a single serving cell.

In some implementations, there may be at least two conditions for multiple cell scheduling.

One condition: for a set of cells configured for multi-cell scheduling, existing DCI size budget is maintained on each cell of the set of cells; DCI size of DCI format 0_X/1_X is counted on one cell among the set of cells (e.g., DCI size of the DCI format 0_X/1_X being counted on the reference cell); BD/CCE of DCI format 0_X/1_X is counted on one cell among the set of cells (e.g., BD/CCE of the DCI format 0_X/1_X being counted on the reference cell); same reference cell is used for both DCI format 0_X and DCI format 1_X.

The condition may further include that, for a set of cells configured for multi-cell scheduling, the reference cell is: the scheduling cell when the scheduling cell is included in the set of cells and search space of the DCI format 0_X/1_X is configured only on the scheduling cell; one cell of the set of cells which search space of DCI format 0_X/1_X is configured on and associated with the search space of the scheduling cell with the same search space ID when search space of the DCI format 0_X/1_X is configured on the cell in addition to the scheduling cell, e.g., it is up to gNB on which cell the SS of the DCI format 0_X/1_X is configured on.

The condition may further include that, for a set of cells configured for multi-cell scheduling, to address BD/CCE limit for any given cell: for the reference cell, a total number of configured BD/CCEs for both DCI formats 0_X/1_X and legacy DCI formats (if configured) does not exceed a pre-defined limits; for other cells in the sets of cells, one or more predefined limits for PDCCH/DCI monitoring and BD/CCE counting rules for legacy DCI formats (not including DCI formats 0_X/1_X) apply.

Another condition: for monitoring PDCCH candidates for a set of cells which is configured for multi-cell scheduling, the n_CI in the search space equation is determined by a value configured for the set of cells by RRC signaling.

In some implementations, the maximum number

$${M}_{PDCCH}^{max , slot , μ}$$

of monitored PDCCH candidates per slot for a DL BWP with SCS configuration μ∈{0, 1,2,3} for a single serving cell is shown as Table 1, wherein μ∈{0, 1,2,3} is corresponding to 15 khz, 30 khz, 60 khz and 120 khz respectively. In some implementations, the maximum number

$${C}_{PDCCH}^{max , slot , μ}$$

of non-overlapped CCEs per slot for a DL BWP with SCS configuration μ∈{0, 1,2,3} for a single serving cell is shown as Table 2.

TABLE 1
Maximum number of monitored PDCCH
candidates (or Blind Decodes (BDs))

| | Maximum number of monitored PDCCH candidates |
|---|---|
| μ | per slot and per serving cell M_{PDCCH}^{max, slot, μ} |
| 0 | 44 |
| 1 | 36 |
| 2 | 22 |
| 3 | 20 |

TABLE 2
Maximum number of non-overlapped CCEs

| | Maximum number of non-overlapped CCEs per |
|---|---|
| μ | slot and per serving cell C_{PDCCH}^{max, slot, μ} |
| 0 | 56 |
| 1 | 56 |
| 2 | 48 |
| 3 | 32 |

In some implementations, when a UE is configured with

$${N}_{cells}^{DL , μ}$$

downlink cells with DL BWPs having SCS configuration μ, where

$${\sum }_{μ = 0}^{3} {N}_{cells}^{DL , μ} > {N}_{cells}^{cap} ,$$

a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than

$${M}_{PDCCH}^{total , slot , μ} = ⌊ {N}_{cells}^{cap} \cdot {M}_{PDCCH}^{max , slot , μ} \cdot {N}_{cells}^{DL , μ} / {\sum }_{j = 0}^{3} {N}_{cells}^{DL , j} ⌋$$

PDCCH candidates or more than

$${C}_{PDCCH}^{total , slot , μ} = ⌊ {N}_{cells}^{cap} \cdot {C}_{PDCCH}^{max , slot , μ} \cdot {N}_{cells}^{DL , μ} / {\sum }_{j = 0}^{3} {N}_{cells}^{DL , j} ⌋$$

non-overlapped CCEs per slot on the active DL BWP(s) of scheduling cell(s) from the

$${N}_{cells}^{DL , μ}$$

downlink cells.

In some implementations, there may be a DCI size budget for a UE per serving cell. That is, UE is not expected to handle the total number of different DCI sizes configured to monitor is more than 4 for the cell; or the total number of different DCI sizes with C-RNTI configured to monitor is more than 3 for the cell.

Referring to FIG. 4A, the present disclosure describes various embodiments of a method 400 for wireless communication. The method 400 may be performed by a wireless communication device (e.g., a user equipment). The method 400 may include a portion or all of the following steps: step 410, receiving a configuration including a value for a first set of cells, a first user-specific search space (USS) of a multi-cell scheduling downlink control information (MC-DCI) on a scheduling cell, a second USS on a scheduled cell associated with the first USS; and/or step 412, determining resource of the first and second USS on the scheduling cell.

In some embodiments, a method may be performed by a wireless communication device (e.g., a user equipment). The method may include a portion or all of the following: receiving a configuration of a value for a first set of cells; receiving a first configuration for a first user-specific search space (USS) of a multi-cell scheduling downlink control information (MC-DCI) on a scheduling cell; receiving a second configuration of a second USS on a scheduled cell associated with the first USS; and/or determining resource of the first and second USS on the scheduling cell.

Referring to FIG. 4B, the present disclosure describes various embodiments of another method 430 for wireless communication. The method 430 may be performed by a wireless communication node (e.g., a base station or a radio access network (RAN)). The method 430 may include step 440, sending a configuration including a value for a first set of cells, a first user-specific search space (USS) of a multi-cell scheduling downlink control information (MC-DCI) on a scheduling cell, a second USS on a scheduled cell associated with the first USS, so that upon receiving the configuration, a wireless communication device is configured to determine resource of the first and second USS on the scheduling cell.

In some embodiments, a method may be performed by a wireless communication node (e.g., a base station or a radio access network (RAN)). The method may include a portion or all of the following: sending a configuration of a value for a first set of cells; sending a first configuration for a first user-specific search space (USS) of a multi-cell scheduling downlink control information (MC-DCI) on a scheduling cell; and/or sending a second configuration of a second USS on a scheduled cell associated with the first USS, so that a wireless communication device is configured to perform determining resource of the first and second USS on the scheduling cell.

In some implementations, the value is configured as a carrier indicator filed (CIF) of the scheduled cell.

In some implementations, the first set of cells comprises the scheduled cell, the first set of cells is configured for multi-cell scheduling by the MC-DCI on the scheduling cell; and/or the first USS and the second USS has a same search space identifier (ID).

In some implementations, the reference cell comprises one of the following: the scheduling cell carrying the MC-DCI or the scheduled cell in the first set of cells.

In some implementations, the MC-DCI is one of the following: a DCI of format 0_x or a DCI of format 1_x.

In some implementations, the value comprises a value of a carrier indicator filed (CIF) for the first set of cells.

In some implementations, the step of determining the resource of the first and second USS on the scheduling cell comprises determining control channel element (CCE) indexes corresponding to candidates configured in the first USS or the second USS or the combined In some implementations, candidates are counted on the scheduled cell based on candidates in the first USS and candidates in the second USS.

In some implementations, the candidates of an aggregation level are counted as a summation of candidates of the same aggregation level in the first USS and in the second USS; and/or CCE resource corresponding to the summation of candidates in the combined USS is derived based on the value for the first set of cells.

In some implementations, CCE resource corresponding to candidates in the first USS and candidates in the second USS is derived based on the value for the first set of cells, respectively, and/or the candidates of an aggregation level are counted as a summation of candidates of the same aggregation level in the first USS and in the second USS, and in response to any two candidates in the first USS and the second USS overlapping with each other, only one of the two candidates is counted.

In some implementations, the following of the MC-DCI is configured to count on the scheduled cell: at least one DCI size, at least one blind decode, or at least one non-overlapped control channel element (CCE), the following of the MC-DCI is configured to count on the scheduling cell: at least one DCI size, at least one blind decode, or at least one non-overlapped control channel element (CCE), and/or the following of the MC-DCI is configured to count on the scheduled cell and the scheduling cell, respectively: at least one DCI size, at least one blind decode, or at least one non-overlapped control channel element (CCE).

In some implementations, the candidates configured in the first USS and in the second USS are both counted on the scheduled cell; and/or CCE resource corresponding to the candidates in the first USS is derived based on a first value for the scheduling cell, and the CCE resource corresponding to the candidates in the second USS is derived based on the value for the first set of cells.

In some implementations, the candidates configured in the first USS are counted on the scheduling cell and the candidates configured in the second USS are counted on the scheduled cell; and/or CCE resource corresponding to the candidates in the first USS is derived based on a first value for the scheduling cell, and the CCE resource corresponding to the candidates in the second USS is derived based on the value for the first set of cells.

In some implementations, candidates in the second USS are counted on the scheduled cell; and/or CCE resource corresponding to the candidates in the second USS is determined based on the value for the first set of cells.

In some implementations, candidates in the first USS are discarded, and/or a number of the candidates in the first USS is configured as zero.

In some implementations, in addition to the first set of cells, at least one more set of cells is configured for multi-cell scheduling by the MC-DCI on the same scheduling cell, and a third USS configured on a scheduled cell of another set of cells has the same search space identifier (ID) with the first and the second USS; CCE resource corresponding to candidates in the first USS is determined based on a value for each set of cells, respectively; the candidates of the first USS and the second USS are counted on the scheduled cell in the first set of cells; and/or the candidates of the first USS and the third USS are counted on the scheduled cell in the another set of cells.

In some implementations, in addition to the first set of cells, at least one more set of cells is configured for multi-cell scheduling by the MC-DCI on the same scheduling cell, and a third USS configured on a scheduled cell of another set of cells has the same search space identifier (ID) with a fourth USS configured on the scheduling cell; and/or the search space configured with MC-DCI formats comprise a parameter of set index or a second value of a set of cells.

Referring to FIG. 4C, the present disclosure describes various embodiments of another method 450 for wireless communication. The method 450 may be performed by a wireless communication device (e.g., a user equipment or a mobile terminal). The method 450 may include a portion or all of the following steps: step 460, receiving a configuration of a search space of a multi-cell scheduling downlink control information (MC-DCI) for at least one set of cells, wherein: the at least one set of cells is configured for multi-cell scheduling, and/or at least one cell of the at least one set of cells is scheduled by the MC-DCI on a physical downlink control channel (PDCCH) candidate on a scheduling cell; and/or step 462, in response to the MC-DCI comprising a specific field, applying a set of specific functions based on the specific field.

Referring to FIG. 4D, the present disclosure describes various embodiments of another method 470 for wireless communication. The method 470 may be performed by a wireless communication node (e.g., a base station or a radio access network (RAN)). The method 470 may include step 480, sending a configuration of a search space of a multi-cell scheduling downlink control information (MC-DCI) for at least one set of cells, wherein: the at least one set of cells is configured for multi-cell scheduling, at least one cell of the at least one set of cells is scheduled by the MC-DCI on a physical downlink control channel (PDCCH) candidate on a scheduling cell, and/or a wireless communication device, upon receiving the configuration and in response to the MC-DCI comprising a specific field, is configured to apply a set of specific functions based on the specific field.

In some implementations, in response to the specific field being secondary cell (SCell) dormancy indication, the set of specific function comprises: applying one of the following conditions: frequency domain resource allocation (FDRA) fields of all co-scheduled cells at a time satisfying a condition, or at least one FDRA field of one scheduled cell of the co-scheduled cells at a time satisfying the condition; and/or in response to the condition being applied, the fields comprising at least one of modulation and coding scheme (MCS), new data indicator (NDI), redundancy version (RV), HARQ processing number (HPN), antenna ports (AP), or DMRS sequence initialization (DSI) are concatenated in one of the following orders: values of one field for the set of cells followed by values of another field for the set of cells, and/or values of all fields for one cell followed by values of all fields for another cell.

In some implementations, in response to the specific field being downlink feedback indicator (DFI), the set of specific function comprises one of the following: using only one cell of co-scheduled cells at a time to indicate for configured grant-DFI (CG-DFI), and using fields of a first type of the cell for hybrid automatic repeat request acknowledgement (HARQ-ACK) bitmap, using all cell of the co-scheduled cells at a time to indicate for CG-DFI, and using all remaining fields as HARQ-ACK bitmap, and/or using only the one or more cell of the co-scheduled cells at a time to indicate for CG-DFI, and using fields of the first type of the cell for HARQ-ACK bitmap.

In some implementations, in response to the specific field being X bits first-type sounding reference signal (SRS) request, the set of specific function comprises one of the following: using the specific field as 1-bit second-type for non-supplementary uplink (non-SUL)/SUL indicator and X−1 bits first-type for SRS, using the specific field as 2-bit second-type for non-SUL/SUL indicator and X−2 bits first-type for SRS, and/or implicitly indicating for non-SUL/SUL by a column in a table configured by higher layer parameter and using the specific field as X bits first-type for SRS, wherein X is an integer larger than two. In some implementations, X is 4.

In some implementations, in response to the specific field being uplink (UL) or supplementary uplink (UL/SUL) indicator and more than one set of cells being introduced: only one set of cells is configured with a first-type UL/SUL indicator, or a number of cells within one cell group is not larger than N, N being a positive integer.

### Embodiment Set I

The present disclosure describes various embodiments, wherein USS with DCI format 0_X/1_X can be configured on two cells based on the following case. The reference cell is one cell of the set of cells which search space of DCI format 0_X/1_X is configured on and associated with the search space of the scheduling cell with the same search space ID if search space of the DCI format 0_X/1_X is configured on the cell in addition to the scheduling cell. In some implementations, it is up to gNB on which cell the SS of the DCI format 0_X/1_X is configured on.

Various embodiments may address the issue that, when both scheduling cell and one scheduled cell configured with USS of DCI format 0_X/1_X, how to derive the USS of DCI format 0_X/1_X based on the n_CI for the set of cells, and how to count the candidates for the reference cell.

In some implementations, USS#A (USS#1 configured on a scheduled cell of the set of cells) and USS#B (USS#1 configured on the scheduling cell) are configured based on SS linkage. There may be two cases: case 1, the scheduling cell is within the set; and case 2, the scheduling cell is not included in the set.

There are following options to resolve the issue: when determining the search space of DCI format 0_X/1_X, using the n_CI for the set of cells, whether only candidates of USS#A or USS#B is counted, or both candidates of USS#A and USS#B is counted.

For option 1, candidates in both USS are counted and CCE resources of candidates in both USS are determined by the n_CI for the set of cells. Option 1-1: sum the candidates of a same aggregation level then using the n_CI for the set of cells to derive the CCE resource of the candidates, counted all the candidates. Option 1-2: using the n_CI for the set of cells to derive the CCE resource of the candidates in each USS respectively, counted as one candidate if overlapped of two candidates of the two USS.

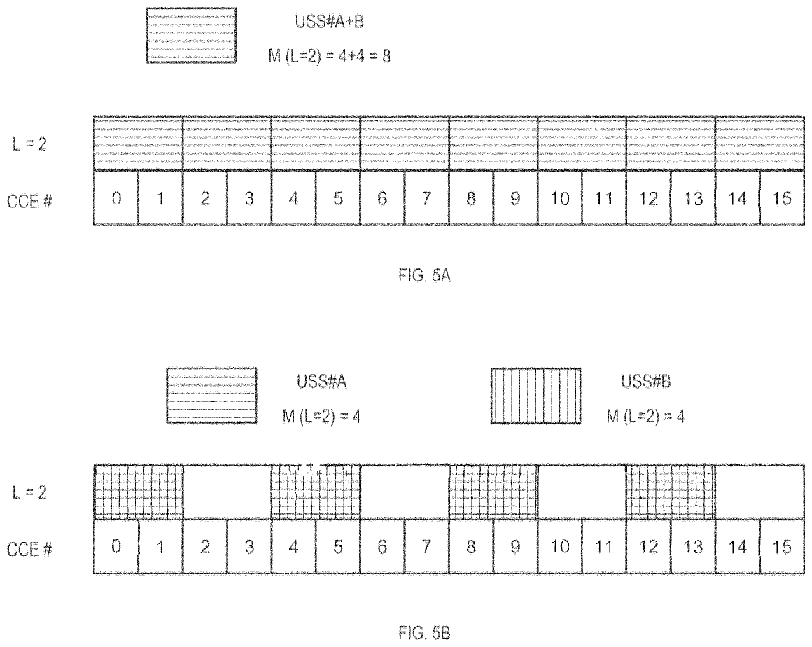

In some implementations, both USS#A and USS#B are counted and candidates in both USS are determined by the n_CI for the set of cells. This option is benefit for the scheduling cell is also within the set of cells and only one reference cell is assumed. While the potential issue is that the candidates in each USS may override with each other. As a result, the number of candidates can be determined based on option 1-1 shown in FIG. 5A, and/or be determined based on option 1-2 as shown in FIG. 5B.

In some implementations, based on option 1-2, BD/CCE or DCI size of the DCI format 0_X/1_X of USS#A and USS#B are counted by one of following. Option 1-2-1: all counted on the scheduled cell. Option 1-2-2: all counted on the scheduled cell, and counted as one candidate if overlapped of two candidates of a same aggregation level of the two USS. Option 1-2-3: candidates of each USS are counted on the scheduled cell and scheduling cell respectively.

For option 2, candidates in both USS are counted and the CCE resources of the candidates in USS configured on the scheduled cell are determined by the n_CI for the set of cells, while the CCE resources of the candidates in USS configured on the scheduling cell are determined by the n_CI of the scheduling cell. BD/CCE or DCI size of the DCI format 0_X/1_X of USS#A and USS#B are counted by one of following. Option 2-1: all counted on the scheduled cell. Option 2-2: candidates of each USS are counted on the scheduled cell and scheduling cell respectively.

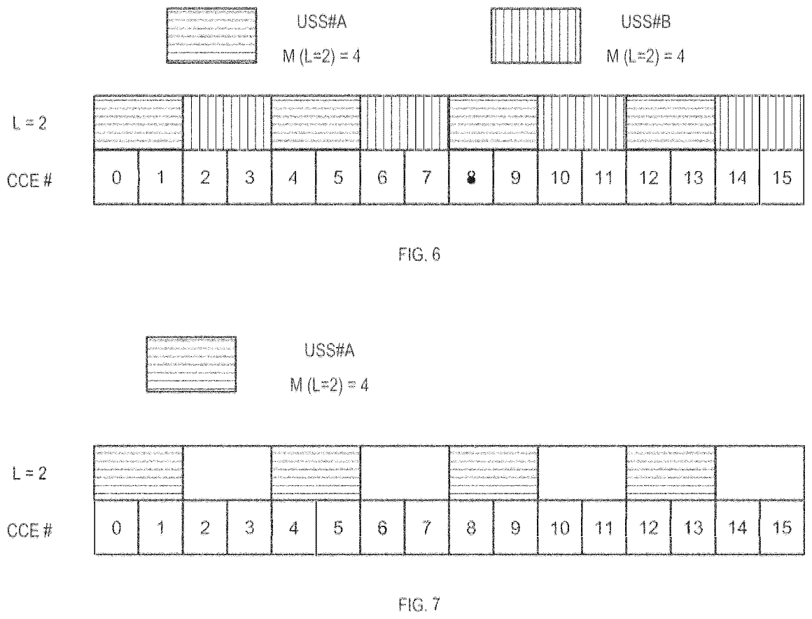

In some implementations, referring to FIG. 6, both USS#A and USS#B are counted and candidates in USS#A are determined by the n_CI for the set of cells. Candidates in USS#B are determined by the n_CI of the scheduling cell. This option is benefit for the operation of the scheduled cell which is simpler and all counted on a reference cell, and the operation of scheduling cell is aligned with current spec which make the CCE resources of USS#A and USS#B more balance on the scheduling cell.

In some implementations, one potential issue may include that it may be not reasonable in case the scheduling cell is out of the set of cells.

For option 3, only the candidates in USS configured on the scheduled cell is counted and the CCE resources of the candidates in USS configured on the scheduled cell are determined by the n_CI for the set of cells. Candidates in USS configured on the scheduling cell are discarded or the number of candidates in USS configured on the scheduling cell is configured as 0.

In some implementations, referring to FIG. 7, only USS#A is counted and candidates in USS#A are determined by the n_CI for the set of cells. Candidates in USS#B are discarded or configured as 0 candidates. This option is benefit for the operation of the scheduled cell with only the candidates configured on itself. Only using the SS linkage but not use the candidates of USS with same ID in the scheduling cell, to avoid resolving the issue of how to count two USS of two cells with same n_CI.

There may be various benefits associated with the various embodiments. For example, in some embodiments, when both scheduling cell and one scheduled cell configured with USS of DCI format 0_X/1_X, how to derive the USS of DCI format 0_X/1_X based on the n_CI for the set of cells, and how to count the candidates for the reference cell are resolved by partially or all counted to determine the CCE resource or the candidates. It is benefit for UE to support this capability to align with the understanding of network on the resource and number of candidates for blind decoding of MC-DCI on the scheduling cell.

### Embodiment Set II

The present disclosure describes various embodiments, wherein, for multi-cell scheduling, multiple sets of cells may be supported. Since up to 4 cells can be configured/co-scheduled, but up to 8 cells can be configured for a cell group, it is reasonable to support at least 2 sets.

In some implementations, for monitoring PDCCH candidates for a set of cells which is configured for multi-cell scheduling, the n_CI in the search space equation is determined by a value configured for the set of cells by RRC signaling. In some implementations, multiple sets of cells scheduled from a same scheduling cell is not supported. In some implementations, multiple sets of cells scheduled from a same scheduling cell is supported, where which set of cells the DCI format 1_X/0_X is associated with is differentiated by network configuration for the multiple sets of cells. In some implementations, multiple sets of cells scheduled from a same scheduling cell is supported, where the DCI format 1_X/0_X has an indication field that indicates which set of cells the DCI format 1_X/0_X is associated with.

Various embodiments describe methods for how to handle more than one set configured. Search space configuration in case of multiple sets of cells scheduled from a same scheduling cell is operated by one of following options.

For option 1, one/same search space with DCI format 0_X/1_X is configured and using n_CI of each set of cells to determine the CCE resources respectively. With this option, although the candidates of one search space will be doubled, they are used for different set of cells respectively.

For option 2, different search space for each set of cells are configured, that is, search space with DCI format 0_X/1_X also comprises a parameter of set index or n_CI of a set of cells. With this option, the search space configuration will further comprise a parameter of scheduling for which set of cells. For example, a set index is added in the USS configuration.

There may be various benefits associated with the various embodiments. For example, in some embodiments, when multiple sets of cells scheduled from a same scheduling cell is supported, one or different search space can be configured and used for more than one set of cells. It is benefit for capacity or load balance of CCE resource of MC-DCI for different sets of cells.

### Embodiment Set III

The present disclosure describes various embodiments, wherein, for multi-cell scheduling, when the secondary cell (SCell) dormancy indication field is configured in the MC-DCI, how to apply the function based on the MC-DCI is disclosed in the embodiment.

In some implementations, the SCell dormancy indication field in current DCI format may be described as the following. SCell dormancy indication may have 0 bit when a higher layer parameter dormancyGroupWithinActiveTime is not configured; otherwise 1, 2, 3, 4 or 5 bits bitmap determined according to the number of different DormancyGroupID(s) provided by the higher layer parameter dormancyGroupWithinActiveTime, where each bit corresponds to one of the SCell group(s) configured by higher layers parameter dormancyGroupWithinActiveTime, with most significant bit (MSB) to least significant bit (LSB) of the bitmap corresponding to the first to last configured SCell group in ascending order of DormancyGroupID. The field is only present when this format is carried by PDCCH on the primary cell within discontinuous reception (DRX) active time and the UE is configured with at least two DL BWPs for an SCell.

In some implementations, when one-shot HARQ-ACK request is not present or set to ‘0’, and all bits of frequency domain resource assignment are set to 0 for resource allocation type 0 or set to 1 for resource allocation type 1 or set to 0 or 1 for dynamic switch resource allocation type, this field is reserved and the following fields among the fields above are used for SCell dormancy indication, where each bit corresponds to one of the configured SCell(s), with MSB to LSB of the following fields concatenated in the order below corresponding to the SCell with lowest to highest SCell index: modulation and coding scheme of transport block 1; new data indicator of transport block 1; redundancy version of transport block 1; hybrid automatic repeat request (HARQ) process number; antenna port(s); and demodulation reference signal (DMRS) sequence initialization.

In some implementations, one condition to apply the SCell dormancy indication may include whether one-shot HARQ-ACK request is not present or set to ‘0’, and all bits of frequency domain resource assignment are set to 0 for resource allocation type 0 or set to 1 for resource allocation type 1 or set to 0 or 1 for dynamic switch resource allocation type.

In some implementations, one-shot HARQ-ACK request is Type 1A, and/or frequency domain resource allocation (FDRA) is Type 2.

In various embodiments/implementations in the present disclosure, Type 1A field is a single field indicating common information to all the co-scheduled cells; Type-1B field is a single field indicating separate information to each of co-scheduled cells via joint indication; Type-1C field is a single field indicating an information to only one of co-scheduled cells. Type-2 field is separate field for each of the co-scheduled cells. Type-3 field: Common or separate to each of the co-scheduled cells, or separate to each sub-group, dependent on explicit configuration.

In some implementations, in case of MC-DCI, application of the condition is one of following. Alt.1: FDRA fields of all the co-scheduled cells at a time satisfied the condition. Alt.2: at least one FDRA field of one scheduled cell of the co-scheduled cells at a time satisfied the condition.

In some implementations, when the condition is applied, all or a portion of the following fields, including modulation and coding scheme (MCS), new data indicator (NDI), redundancy version (RV), HARQ processing number (HPN), antenna ports (AP), or DMRS sequence initialization (DSI), concatenated in the order are used based on one of following. Alt.1 field first; Alt.2 cell first; Alt.3 Alt.1/2 and only use the type 2 fields; Alt.4 Alt.2 and Type 1A field used as field of first/last cell.

For one non-limiting example, when the fields of all the co-scheduled cells (e.g. cell#1 and cell#2) at a time satisfied the condition, the following fields concatenated in the order are used based on one of following. For Alt.1 (field first): MCS 1 of cell 1, MCS 1 for cell 2, NDI 1 of cell 1, NDI 1 for cell 2, and etc. For Alt.2 (cell first): MCS 1 of cell 1, NDI 1 of cell 1, RV of cell 1, . . . , MCS 1 for cell 2, NDI 1 of cell 2, and RV 1 of cell 2.

In some implementations, because some field are Type 1A (e.g., DMRS sequence initialization), some field are Type 3 (e.g., antenna port(s)), some field are Type 2 (e.g., MCS, RV, NDI, or HPN), when Alt.2 is used, the bit order can be arranged according to one of following.

For one alternative implementation, only the field which is Type 2, including MCS, RV, NDI, HPN may be used. Antenna port(s) may also be used in case configured as type 2. DMRS sequence initialization is not used.

For another alternative implementation, Type 1 field may be used as the field of first/last cell. Thus, DMRS sequence initialization and antenna port(s) when it's configured as type 1A may be used as the field of the first cell or the last cell.

Optionally for another alternative implementation, when above condition only applied for type 1A/1B, field(s) for type 1C may be straightly used for the cell applied the field.

There may be various benefits associated with the implementations/embodiments. For example, in some embodiment, in case the SCell dormancy indication field is configured in the MC-DCI, applying the function based on the MC-DCI can be achieved by one or partial or all FDRA of multi-cell satisfied the condition and using field or cell first to determine the SCell dormancy indication. It is benefit for UE to support this function and align with the understanding of network for SCell dormancy indication in MC-DCI.

### Embodiment Set IV

For multi-cell scheduling, the present disclosure describes various embodiments for applying the function based on the MC-DCI, in case a downlink feedback indicator (DFI) field is configured in the MC-DCI.

In some implementations, the DFI field in current DCI format is listed below. The DCI format 0_1 with CRC scrambled by C-RNTI or CS-RNTI or SP-CSI-RNTI or MCS-C-RNTI may be used to transmit information including a DFI flag. The DFI flag may be 0 or 1 bit. The DFI flag is 1 bit when the UE is configured to monitor DCI format 0_1 with CRC scrambled by CS-RNTI and for operation in a cell with shared spectrum channel access when the higher layer parameter cg-RetransmissionTimer is configured. For a DCI format 0_1 with CRC scrambled by CS-RNTI, the bit value of 0 indicates activating or releasing type 2 CG transmission and the bit value of 1 indicates CG-DFI. For a DCI format 0_1 with CRC scrambled by C-RNTI/SP-CSI-RNTI/MCS-C-RNTI and for operation in a cell with shared spectrum channel access, the bit is reserved. The DFI flag may be 0 bit otherwise in other situations.

In some implementations, when a DCI format 0_1 is used for indicating CG-DFI, all the remaining fields are set as follows. HARQ-ACK bitmap has 16 bits, where the order of the bitmap to HARQ process index mapping is such that HARQ process indices are mapped in ascending order from MSB to LSB of the bitmap. For each bit of the bitmap, value 1 indicates ACK, and value 0 indicates NACK. TPC command for scheduled PUSCH has 2 bits as pre-defined. In some implementations, all the remaining bits in format 0_1 are set to zero.

In some implementations, when DCI format 0_X can be used for indicating CG-DFI, all co-scheduled cells are shared spectrum, and DFI flag is indicated as 1 (type 1A/1C) or all bits with 1 (type 2), the following bits may be cell first or field first to be ordered.

In some implementations, the DFI flag in DCI format 0_X may be Type 1A, or Type 1C, or Type 2.

For one option, in case of type 1C, only one cell of the co-scheduled cells at a time is indicating for CG-DFI, and the type 2 fields of the cell are used for HARQ-ACK bitmap, TPC for PUSCH. In some implementations, Type 2 fields of each cell will be used to indicate HARQ-ACK bitmap, TPC for PUSCH for the cell only.

For another option, in case of type 1A, all cell of the co-scheduled cells at a time are indicating for CG-DFI, and all the remaining fields are set as HARQ-ACK bitmap, TPC for PUSCH with (1) field first or (2) cell first to use the fields for each scheduled cell.

For another option, in case of type 2, only the cell(s) of the co-scheduled cells at a time are indicating for CG-DFI, and the type 2 fields of the cell(s) are used for HARQ-ACK bitmap, TPC for PUSCH, that is type 2 fields of each cell will be used to indicate HARQ-ACK bitmap, TPC for PUSCH with (1) field first or (2) cell first to use the fields for each scheduled cell.

There may be various benefits associated with the embodiments/implementations. For example, in the embodiment, in case the DFI field is configured in the MC-DCI, apply the function based on the MC-DCI can be achieved by using type 2 fields of one or partial or all cells for HARQ-ACK bitmap and TPC for PUSCH. It is benefit for UE to support this function and align with the understanding of network for DFI in MC-DCI.

### Embodiment Set V

For multi-cell scheduling, the present disclosure describes various embodiments for applying the function based on the MC-DCI when N bits Type 1B SRS request is used in the MC-DCI. Optionally, N=4.

In some implementations, a DCI with Format 0_1 may include a UL/SUL indicator. The UL/SUL indicator may be 0 bit for UEs not configured with supplementaryUplink in ServingCellConfig in the cell or UEs configured with supplementaryUplink in ServingCellConfig in the cell but only one carrier in the cell is configured for PUSCH transmission; otherwise, 1 bit as defined in Table 3.

In some implementations, the DCI with Format 0_1 may include a SRS request. The SRS request may have 2 bits as defined by Table 4 for UEs not configured with supplementaryUplink in ServingCellConfig in the cell; 3 bits for UEs configured with supplementaryUplink in ServingCellConfig in the cell where the first bit is the non-SUL/SUL indicator as defined in Table 3 and the second and third bits are defined by Table 4. This bit field may also indicate the associated CSI-RS.

In some implementations, the DCI with Format 0_1 may include an SRS offset indicator, which may have 0, 1 or 2 bits. The SRS offset indicator may have 0 bit if higher layer parameter AvailableSlotOffset is not configured for any aperiodic SRS resource set in the scheduled cell, or if higher layer parameter AvailableSlotOffset is configured for at least one aperodic SRS resource set in the scheduled cell and the maximum number of entries of AvailableSlotOffset configured for all aperiodic SRS resource set(s) is 1; otherwise, [log₂ (K)] bits are used to indicate available slot offset according to Table 5, where K is the maximum number of entries of AvailableSlotOffset configured for all aperiodic SRS resource set(s) in the scheduled cell.

TABLE 3
UL/SUL indicator

| Value of UL/ | |
|---|---|
| SUL indicator | Uplink |
| 0 | The non-supplementary uplink |
| 1 | The supplementary uplink |

TABLE 4
SRS request

| Value | Triggered aperiodic SRS resource set(s) for | Triggered aperiodic SRS resource |
|---|---|---|
| of SRS | DCI format 0_1, 0_2, 1_1, 1_2, and 2_3 | set(s) for DCI format 2_3 configured |
| request | configured with higher layer parameter | with higher layer parameter |
| field | srs-TPC-PDCCH-Group set to ‘typeB’ | srs-TPC-PDCCH-Group set to ‘typeA’ |
| 00 | No aperiodic SRS resource set triggered | No aperiodic SRS resource set triggered |
| 01 | SRS resource set(s) configured by SRS-ResourceSet | SRS resource set(s) configured with |
| | with higher layer parameter aperiodicSRS- | higher layer parameter usage in SRS- |
| | ResourceTrigger set to 1 or an entry in | ResourceSet set to ‘antennaSwitching’ |
| | aperiodicSRS-ResourceTriggerList set to 1 | and resourceType in SRS-ResourceSet |
| | SRS resource set(s) configured by SRS- | set to ‘aperiodic’ for a 1^{st} set of serving |
| | PosResourceSet with an entry in aperiodicSRS- | cells configured by higher layers |
| | ResourceTriggerList set to 1 when triggered by DCI | |
| | formats 0_1, 0_2, 1_1, and 1_2 | |
| 10 | SRS resource set(s) configured by SRS-ResourceSet | SRS resource set(s) configured with |
| | with higher layer parameter aperiodicSRS- | higher layer parameter usage in SRS- |
| | ResourceTrigger set to 2 or an entry in | ResourceSet set to ‘antennaSwitching’ |
| | aperiodicSRS-Resource TriggerList set to 2 | and resourceType in SRS-ResourceSet |
| | SRS resource set(s) configured by SRS- | set to ‘aperiodic’ for a 2^{nd} set of serving |
| | PosResourceSet with an entry in aperiodicSRS- | cells configured by higher layers |
| | ResourceTriggerList set to 2 when triggered by DCI | |
| | formats 0_1, 0_2, 1_1, and 1_2 | |
| 11 | SRS resource set(s) configured by SRS-ResourceSet | SRS resource set(s) configured with |
| | with higher layer parameter aperiodicSRS- | higher layer parameter usage in SRS- |
| | ResourceTrigger set to 3 or an entry in | ResourceSet set to ‘antennaSwitching’ |
| | aperiodicSRS-ResourceTriggerList set to 3 | and resourceType in SRS-ResourceSet |
| | SRS resource set(s) configured by SRS- | set to ‘aperiodic’ for a 3^{rd} set of serving |
| | PosResourceSet with an entry in aperiodicSRS- | cells configured by higher layers |
| | ResourceTriggerList set to 3 when triggered by DCI | |
| | formats 0_1, 0_2, 1_1, and 1_2 | |

TABLE 5
SRS offset indicator

| Bit field | | Bit field | | Bit field | |
|---|---|---|---|---|---|
| mapped | Available slot | mapped | Available slot | mapped | Available slot |
| to index | offset, K = 2 | to index | offset, K = 3 | to index | offset, K = 4 |
| 0 | The 1^{st} entry in | 0 | The 1^{st} entry in | 0 | The 1^{st} entry in |
| | AvailableSlotOffset, | | AvailableSlotOffset, | | AvailableSlotOffset, |
| | if configured for | | if configured for | | if configured for |
| | the aperiodic SRS | | the aperiodic SRS | | the aperiodic SRS |
| | resource set; | | resource set; | | resource set; |
| | 0, otherwise | | 0, otherwise | | 0, otherwise |
| 1 | The 2^{nd} entry in | 1 | The 2^{nd} entry in | 1 | The 2^{nd} entry in |
| | AvailableSlotOffset, | | AvailableSlotOffset, | | AvailableSlotOffset, |
| | if configured for | | if configured for | | if configured for |
| | the aperiodic SRS | | the aperiodic SRS | | the aperiodic SRS |
| | resource set; | | resource set; | | resource set; |
| | 0, otherwise | | 0, otherwise | | 0, otherwise |
| | | 2 | The 3^{rd} entry in | 2 | The 3^{rd} entry in |
| | | | AvailableSlotOffset, | | AvailableSlotOffset, |
| | | | if configured for | | if configured for |
| | | | the aperiodic SRS | | the aperiodic SRS |
| | | | resource set; | | resource set; |
| | | | 0, otherwise | | 0, otherwise |
| | | 3 | Reserved | 3 | The 4^{th} entry in |
| | | | | | AvailableSlotOffset, |
| | | | | | if configured for |
| | | | | | the aperiodic SRS |
| | | | | | resource set; |
| | | | | | 0, otherwise |

In some implementations, for DCI format 0_1, UL/SUL indicator is used to indicate the carrier for PUSCH transmission. The first bit of 3-bit SRS request is the non-SUL/SUL indicator which is used to indicate the carrier for SRS transmission.

In some implementations, the UL/SUL indicator and the non-SUL/SUL indicator can be indicated with different values when UE report an optional feature. The optional UE feature is “Simultaneous transmission of SRS on an SUL/non-SUL carrier and PUSCH/PUCCH/SRS on the other UL carrier in the same cell”.

In some implementations, the type 1B for 4 bits SRS request can be used based on one of following options: option 1: based on Type 1C for UL/SUL indicator; and option 2: based on Type 2 for UL/SUL indicator.

The option 1 includes 1bit non-SUL/SUL indicator+3bits Type 1B for SRS request of 4 co-scheduled cells, or 3bits Type 1B for SRS request of 4 co-scheduled cells if not configured with supplementaryUplink in ServingCellConfig in the cell. The 1 bit non-SUL/SUL indicator only applied for one cell. Table 6 shows 3bits Type 1B for SRS request corresponding to 4 co-scheduled cells, wherein the SRS 0/1/2/3 means the value of 00/01/10/11 in Table 4.

For SRS offset indicator, up to 3 bits can be used similar as Table 6, shown as Table 7, wherein the offset 0/1/2/3 means the value of 00/01/10/11 in Table 5.

TABLE 6
SRS request

| index | cell 0 | cell 1 | cell 2 | Cell 3 |
|---|---|---|---|---|
| 0 | SRS 0 | SRS 0 | SRS 0 | SRS 0 |
| 1 | SRS 1 | SRS 1 | SRS 1 | SRS 1 |
| 2 | SRS 2 | SRS 2 | SRS 2 | SRS 2 |
| 3 | SRS 3 | SRS 3 | SRS 3 | SRS 3 |
| 4 | SRS 0 | SRS 1 | SRS 2 | SRS 3 |
| 5 | SRS 1 | SRS 2 | SRS 3 | SRS 0 |
| 6 | SRS 2 | SRS 3 | SRS 0 | SRS 1 |
| 7 | SRS 3 | SRS 0 | SRS 1 | SRS 2 |

TABLE 7
SRS offset indicator

| index | cell 0 | cell 1 | cell 2 | Cell 3 |
|---|---|---|---|---|
| 0 | offset 0 | 0 or reserved | offset 0 | offset 0 |
| 1 | offset 1 | 0 or reserved | offset 1 | offset 1 |
| 2 | offset 2 | 0 or reserved | offset 0 | offset 2 |
| 3 | offset 3 | 0 or reserved | offset 1 | reserved |
| 4 | offset 0 | 0 or reserved | offset 0 | offset 0 |
| 5 | offset 1 | 0 or reserved | offset 1 | offset 1 |
| 6 | offset 2 | 0 or reserved | offset 0 | offset 2 |
| 7 | offset 3 | 0 or reserved | offset 1 | reserved |

The option 2 may include more than one sub-options, as described below. Option 2-1: 1 bit non-SUL/SUL indicator+3 bits Type 1B for SRS request of 4 co-scheduled cells, or 3bits Type 1B for SRS request of 4 co-scheduled cells if not configured with supplementaryUplink in ServingCellConfig in the cell. The 1 bit type 1A non-SUL/SUL indicator applied for all cells. Option 2-2: 2 bits non-SUL/SUL indicator+2 bits Type 1B for SRS request of 4 co-scheduled cells, or 2 or 3 bits Type 1B for SRS request of 4 co-scheduled cells if not configured with supplementaryUplink in ServingCellConfig in the cell. The 2 bits type 1B non-SUL/SUL indicator applied for all cells. Option 2-3: 0bit non-SUL/SUL indicator (implicitly indicated by additional column in a RRC table)+4bits Type 1B for SRS request of 4 co-scheduled cells. When not configured with supplementaryUplink in ServingCellConfig in the cell, UE may discard the non-SUL/SUL indicator for the cell. Optionally, configuration restrictions are introduced to not permit at least one of SUL+SUL, SUL+non-corresponding NUL, that is, simultaneously SRS transmission among cells on SUL carrier and other SUL carrier, or on SUL carrier and non-corresponding NUL carrier may be supported or not, may be further depend on UE capabilities.

TABLE 8
SUL and non-SUL

| | | non-SUL/SUL | | non-SUL/SUL | | non-SUL/SUL | | non-SUL/SUL |
|---|---|---|---|---|---|---|---|---|
| | | indicator for | | indicator for | | indicator for | | indicator for |
| index | cell 0 | cell 0 | cell 1 | cell 1 | cell 2 | cell 2 | Cell 3 | cell 3 |
| 0 | SRS 0 | Non-SUL | SRS 0 | Non-SUL | SRS 0 | Non-SUL | SRS 0 | Non-SUL |
| 1 | SRS 1 | Non-SUL | SRS 1 | SUL | SRS 1 | Non-SUL | SRS 1 | SUL |
| 2 | SRS 2 | SUL | SRS 2 | SUL | SRS 2 | SUL | SRS 2 | SUL |
| 3 | SRS 3 | Non-SUL | SRS 3 | Non-SUL | SRS 3 | Non-SUL | SRS 3 | Non-SUL |
| 4 | SRS 0 | SUL | SRS 1 | Non-SUL | SRS 2 | Non-SUL | SRS 3 | Non-SUL |
| 5 | SRS 1 | Non-SUL | SRS 2 | Non-SUL | SRS 3 | Non-SUL | SRS 0 | Non-SUL |
| . . . | . . . | | . . . | | . . . | | . . . | |
| 15 | SRS 3 | Non-SUL | SRS 0 | SUL | SRS 1 | Non-SUL | SRS 2 | SUL |

In some implementations, simultaneously SRS transmission among cells can be supported in Table 8, regardless on SUL carrier and other SUL carrier, or on SUL carrier and non-corresponding NUL carrier. When simultaneously SRS transmission among cells on UL carrier and other SUL carrier are not supported, index x=1/2 are not supported. When simultaneously SRS transmission among cells on UL carrier and non-corresponding NUL carrier are not supported, index x=15 are not supported.

In some implementations, for SRS offset indicator, up to 3 bits can be used also shown as Table 7. The SRS offset indicator field is not related to UL/SUL indicator.

To summarize some embodiments, 4 bits type 1B SRS request field in MC-DCI format is used by one of following: 1 bit Type 1A/1C non-SUL/SUL indicator+3bits Type 1B for SRS; 2 bits type 1B non-SUL/SUL indicator+2/3bits Type 1B for SRS; or 0 bit non-SUL/SUL indicator (implicitly indicated by additional column in the RRC table)+4bits Type 1B for SRS request of 4 co-scheduled cells. Optionally, configuration restrictions are introduced to not permit at least one of SUL+SUL, SUL+non-corresponding NUL.

There may be various benefits associated some embodiments/implementations. For example, in the embodiment, in case the type 1B SRS request field is used in the MC-DCI, apply the function based on the MC-DCI can be achieved by using explicitly or implicitly indication of non-SUL/SUL indicator. It is benefit for UE to support this function and align with the understanding of network for SRS request in MC-DCI.

### Embodiment Set VI

For multi-cell scheduling, the present disclosure describes various embodiments for applying the function based on the MC-DCI when the UL/SUL indicator field is configured in MC-DCI.

In some implementations, three alternatives/options are tried to down-selected for UL/SUL indicator field in MC-DCI. For one alternative, UL/SUL indicator in a DCI format 0_X for multi-cell PUSCH scheduling is 1 bit (when it is present), which is for one serving cell within the set of co-scheduled cells (i.e., Type 1C). For another alternative, UL/SUL indicator in a DCI format 0_X for multi-cell PUSCH scheduling is sum of {0, 1} bits for each cell in the set configured for the DCI format 0_X (i.e., Type 2). For another alternative, UL/SUL indicator field is excluded from a DCI format 0_X. In some implementations, all or a portion of the above alternatives are only focus on the case of one set of cells.

When Type 1C is used for UL/SUL indicator, various embodiments are described for how to determine the number of cells configured with SUL carrier when two sets of cells are supported. For example, there are 8 cells (cell#0/1/2/3/4/5/6/7) in one cell group, set#0 are configured with cell#0/1/2/3, and set#1 are configured with cell#4/5/6/7. When type 1C for UL/SUL indicator is agreed, only one cell with SUL can be supported by one of following options. In some implementations, when the intention is to restrict that there is only cell with SUL within a cell group, some other restrictions may be considered.

For option 1, only 1 set can be configured with UL/SUL indicator. That is, regardless more than one, i.e. 2 or 4 sets are supported, only 1 set can be configured with the Type IC UL/SUL indicator field.

For option 2, more than one set is not supported in case the number of cells is not larger than 4. It is benefit when there are not many cells in one cell group.

For option 3, it may not support more than one set.

For option 4, the number of cells within one set may not be configured as 1. That is, the number of cells within one Set can be configured as 2, 3 or 4. Otherwise, it will make multi-cell scheduling by MC-DCI equivalent as single cell scheduling by SC-DCI.

In some implementations, when more than one set are introduced, UL/SUL indicator can be used when: only 1 set can be configured with Type 1C UL/SUL indicator; and/or when further combined with the number of cells within one cell group is not larger than N, e.g. N=4.

There are various benefits associated with the described embodiments/implementations. For example, in some embodiment, when the UL/SUL indicator field is used in the MC-DCI and more than one sets of cells are configured, and when type 1C for UL/SUL indicator is agreed, only one cell with SUL can be supported by additional restrictions.

It is benefit for UE to support this function and align with the understanding of network for UL/SUL indicator in MC-DCI.

### Embodiment Set VII

For multi-cell scheduling, the present disclosure describes various embodiments for applying the function based on the MC-DCI when N bits Type 1 Time domain resource allocation (TDRA) is used in the MC-DCI.

In some implementations, for the multi-cell scheduling, for TDRA indication, a portion or all of the following agreements may be satisfied. A first agreement includes that, for a set of cells co-scheduled by a DCI format 0_X/1_X, time domain resource allocations for the set of cells are indicated by a single TDRA field in the DCI format 0_X/1_X, wherein separate {SLIV, mapping type, scheduling offset K0 (or K2)} is indicated for each of co-scheduled PDSCHs/PUSCHs. A second agreement includes that, For DCI format 1_X/0_X, Type-1 fields at least include a portion or all of the following: ChannelAccess-Cpext and/or TDRA.

In some implementations, to indicate separate time domain resource allocation for the set of cells by a single TDRA field, a row in the TDRA table may include the time domain resource allocation for each scheduled cell. There could be various options for the TDRA table design.

Option 1: The network can configure the TDRA table for each scheduled cell. The TDRA table is the combination of the TDRA table of the scheduled cells. It can be seen as that TDRA is Type-1A field with independent RRC configuration. The row index indicated by the TDRA field is shared by each scheduled cell and separate {SLIV, mapping type, scheduling offset K0 (or K2)} is indicated according to each TDRA table for each scheduled cell.

Option 2: The network can configure the a new TDRA table for multi-cell PDSCH/PUSCH scheduling. Each row of the new TDRA table could be configured with separate {SLIV, mapping type, scheduling offset KO (or K2)} for multiple scheduled cell(s) which is Type-1B field. The TDRA table for each scheduled cell may be also configured for single cell scheduling. The TDRA field length depends on the number of configured rows in the table.

When different size of TDRA of each cell in option 1, or if the new TDRA table in option 2 is not configured and fall back to option 1, various implementations are described to illustrate how to understand the indication based on type 1A field of TDRA. For example, a set of cells comprise cell 1 and cell 2, based on option 1, the TDRA table for PDSCH of cell 1 is configured as 2 bits with 4 entries as shown in Table 9, and the TDRA table for PDSCH of cell 2 is 3 bits with 8 entries as shown in Table 10. In case the co-scheduled cells including both cell 1 and cell 2, and TDRA field based on type 1A are 3 bits based on the largest size of the cells within the set of cells, when TDRA field indicating ‘000’ means entries index is 0, then PDSCH on each cell will be scheduled according to entries index=0 of each TDRA table. When TDRA field indicating ‘100’ means entries index is 4, how to schedule the PDSCH can be determined by one of following options. In other words, when the TDRA field indicating an invalid value or a value not exist in the configured TDRA table of one or more cells, how to schedule the PDSCH can be determined by one of following schemes.

Scheme 1: Only the PDSCH with available TDRA entries may be scheduled. That is PDSCH on cell 2 may be scheduled according to entries index=4 of the TDRA table configured in cell 2, no PDSCH on cell 1 may be scheduled.

Scheme 2: PDSCH on each cell may be scheduled according to entries index=(indicated index) Mod (the total number of entries) of each TDRA table. That is PDSCH on cell 1 may be scheduled according to entries index=4 Mod 4=0 of the TDRA table configured in cell 1, PDSCH on cell 2 may be scheduled according to entries index=4 Mod 8=4 of the TDRA table configured in cell 2.

Scheme 3: PDSCH on a cell may be scheduled according to entries index of another cell with the valid entries. That is PDSCH on cell 2 may be scheduled according to entries index=4 of the TDRA table configured in cell 2. PDSCH on cell 1 may be scheduled according to same time domain resource allocation of the PDSCH on cell#2. Optionally, when there are more than one cell without valid indication, they are all applied the same time domain resource allocation of another cell with valid entries. Optionally, when there are more than one cell with valid indication, the PDSCH on the cell with invalid indication are all applied the same time domain resource allocation of the cell with valid entries, wherein the cell is a cell with a lowest or largest or predefined cell index.

TABLE 9
TDRA table (2 bits)

| TDRA table | | SLIV or | Mapping |
|---|---|---|---|
| entries (index) | K0 | (S, L) | type |
| 0 | 0 | (0, 14) | Type A |
| 1 | 0 | (7, 14) | Type B |
| 2 | 1 | (0, 14) | Type A |
| 3 | 1 | (7, 14) | Type B |

TABLE 10
TDRA table (3 bits)

| TDRA table | | SLIV or | Mapping |
|---|---|---|---|
| entries (index) | K0 | (S, L) | type |
| 0 | 0 | (0, 14) | Type A |
| 1 | 0 | (7, 14) | Type B |
| 2 | 1 | (0, 14) | Type A |
| 3 | 1 | (7, 14) | Type B |
| 4 | 0 | (3, 14) | Type A |
| 5 | 0 | (13, 14) | Type B |
| 6 | 2 | (0, 14) | Type A |
| 7 | 2 | (7, 14) | Type B |

The present disclosure describes various embodiments for resource determination mechanism with a multi-cell scheduling downlink control information (MC-DCI).

Some embodiments provide solutions that when both scheduling cell and one scheduled cell configured with USS of DCI format 0_X/1_X, how to derive the USS of DCI format 0_X/1_X based on the n_CI for the set of cells, and/or how to count the candidates for the reference cell.

In option 1, candidates in both USS are counted and CCE resources of candidates in both USS are determined by the n_CI for the set of cells. Option 1-1: sum the candidates of a aggregation level then using the n_CI for the set of cells to derive the CCE resource of the candidates, counted all the candidates. Option 1-2: using the n_CI for the set of cells to derive the CCE resource of the candidates in each USS respectively, counted as one candidate if overlapped of two candidates of the two USS.

In option 2, candidates in both USS are counted and the CCE resources of the candidates in USS configured on the scheduled cell are determined by the n_CI for the set of cells, while the CCE resources of the candidates in USS configured on the scheduling cell are determined by the n_CI of the scheduling cell. Option 2-1: all counted on the scheduled cell. Option 2-2: counted on the scheduled cell and scheduling cell respectively.

In option 3, only the candidates in USS configured on the scheduled cell is counted and the CCE resources of the candidates in USS configured on the scheduled cell are determined by the n_CI for the set of cells. Candidates in USS configured on the scheduling cell are discarded or the number of candidates in USS configured on the scheduling cell is configured as 0.

Some embodiments describe search space configuration in case of multiple sets of cells scheduled from a same scheduling cell. Option 1: same search space with DCI format 0_X/1_X and using n_CI of each set of cells to determine the CCE resources respectively. Option 2: different search space for each set of cells, that is, search space with DCI format 0_X/1_X also comprise a parameter of set index or n_CI of a set of cells.

Some embodiments provide implementation corresponding to SCell dormancy indication. For application of the condition: Alt.1 FDRA fields of all the co-scheduled cells at a time satisfied the condition; Alt.2 at least one FDRA field of one scheduled cell of the co-scheduled cells at a time satisfied the condition. In some implementations, when the condition is applied, the following fields (MCS, NDI, RV, HPN, AP, DSI) concatenated in the order are used based on one of following. Alt.1 field first; Alt.2 cell first; Alt.3 field or cell first, and only use the type 2 fields; Alt.4 cell first and Type 1A field used as field of first/last cell.

Some embodiments provide implementation corresponding to DFI flag. DFI flag in DCI format 0_X can be Type 1A/1C/2. Alt.1 In case of type 1C, only one cell of the co-scheduled cells at a time is indicating for CG-DFI, and the type 2 fields of the cell are used for HARQ-ACK bitmap, TPC for PUSCH, that is type 2 fields of each cell will be used to indicate HARQ-ACK bitmap, TPC for PUSCH for the cell only. Alt.2 In case of type 1A, all cell of the co-scheduled cells at a time are indicating for CG-DFI, and all the remaining fields are set as HARQ-ACK bitmap, TPC for PUSCH with (1) field first or (2) cell first for each scheduled cell. Alt.3 In case of type 2, only the cell(s) of the co-scheduled cells at a time is indicating for CG-DFI, and the type 2 fields of the cell(s) are used for HARQ-ACK bitmap, TPC for PUSCH, that is type 2 fields of each cell will be used to indicate HARQ-ACK bitmap, TPC for PUSCH for the cell only.

Some embodiments provide implementation corresponding to 4 bits type 1B SRS request field in MC-DCI format. The 4 bits type 1B SRS request field in MC-DCI format is used by one of following. Alt.1: 1bit Type 1A/1C non-SUL/SUL indicator+3bits Type 1B for SRS. Alt.2: 2bits type 1B non-SUL/SUL indicator+2/3bits Type 1B for SRS. Alt.3 0bit non-SUL/SUL indicator (implicitly indicated by additional column in the RRC table)+4bits Type 1B for SRS request of 4 co-scheduled cells. Optionally, configuration restrictions are introduced to not permit at least one of SUL+SUL, SUL+non-corresponding NUL.

Some embodiments provide implementation corresponding to UL/SUL indicator. When more than one set are introduced, UL/SUL indicator can be used by: (1) Only 1 set can be configured with Type IC UL/SUL indicator; (2) Further combined with the number of cells within one cell group is not larger than N, e.g. N=4.

The present disclosure describes methods, apparatus, and computer-readable medium for wireless communication. The present disclosure addressed the issues with resource determination mechanism with a multi-cell scheduling downlink control information (MC-DCI). The methods, devices, and computer-readable medium described in the present disclosure may facilitate the performance of wireless communication by resolving issues/problems associated with resource determination mechanism with MC-DCI, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, performed by a wireless communication device, comprising:
receiving a configuration including a value for a first set of cells, a first user-specific search space (USS) of a multi-cell scheduling downlink control information (MC-DCI) on a scheduling cell, and a second USS on a scheduled cell associated with the first USS; and
determining resources of the first USS and the second USS on the scheduling cell.

2. The method of claim 1, wherein:
the first set of cells comprises the scheduled cell;
the first set of cells is configured for multi-cell scheduling by the MC-DCI on the scheduling cell; and
the first USS and the second USS has a same search space identifier (ID).

3. The method of claim 1, wherein the determining the resource of the first and second USS on the scheduling cell comprises:
determining control channel element (CCE) indexes corresponding to candidates configured in the first USS, the second USS, or a combined USS comprising candidates in the first USS and the second USS.

4. The method of claim 1, wherein:
candidates are counted on the scheduled cell based on candidates in the first USS and candidates in the second USS.

5. The method of claim 4, wherein:
candidates of an aggregation level are counted as a summation of candidates of a same aggregation level in the first USS and in the second USS; and
a CCE resource corresponding to the summation of candidates of the same aggregation level in the first USS and in the second USS is derived based on the value for the first set of cells.

6. The method of claim 4, wherein:
CCE resources corresponding to the candidates in the first USS and the candidates in the second USS are derived based on the value for the first set of cells, respectively;
candidates of an aggregation level are counted as a summation of candidates of a same aggregation level in the first USS and in the second USS; and
in response to any two candidates in the first USS and the second USS overlapping with each other, only one of the two candidates is counted.

7. The method of claim 4, wherein:
the candidates in the first USS and the candidates in the second USS are both counted on the scheduled cell;
a CCE resource corresponding to the candidates in the first USS is derived based on a first value for the scheduling cell; and
the CCE resource corresponding to the candidates in the second USS is derived based on the value for the first set of cells.

8. The method of claim 4, wherein:
the candidates in the first USS are counted on the scheduling cell;
the candidates in the second USS are counted on the scheduled cell;
a CCE resource corresponding to the candidates in the first USS is derived based on a first value for the scheduling cell; and
a CCE resource corresponding to the candidates in the second USS is derived based on the value for the first set of cells.

9. The method of claim 1, wherein:
candidates in the second USS are counted on the scheduled cell; and
a CCE resource corresponding to the candidates in the second USS is determined based on the value for the first set of cells, and wherein:
candidates in the first USS are discarded, or
a number of the candidates in the first USS is configured as zero.

10. The method of claim 1, wherein:
in addition to the first set of cells, at least one more set of cells is configured for multicell scheduling by the MC-DCI on the scheduling cell;
a third USS configured on a scheduled cell of another set of cells has a same search space identifier (ID) with the first USS and the second USS;
a CCE resource corresponding to candidates in the first USS is determined based on a value for each set of cells, respectively;
the candidates in the first USS and the candidate in the second USS are counted on the scheduled cell in the first set of cells; and
the candidates in the first USS and candidates in the third USS are counted on the scheduled cell of the another set of cells.

11. The method of claim 1, wherein:
in addition to the first set of cells, at least one more set of cells is configured for multicell scheduling by the MC-DCI on the scheduling cell;
a third USS configured on a scheduled cell of another set of cells has a same search space identifier (ID) with a fourth USS configured on the scheduling cell; and
a search space configured with MC-DCI formats comprise a parameter of set index or a second value of a set of cells.

12. A method for wireless communication, performed by a wireless communication node, comprising:
sending a configuration including a value for a first set of cells, a first user-specific search space (USS) of a multi-cell scheduling downlink control information (MC-DCI) on a scheduling cell, and a second USS on a scheduled cell associated with the first USS to another wireless communication device for determining resources of the first USS and the second USS on the scheduling cell.

13. The method of claim 12, wherein:
the first set of cells comprises the scheduled cell;
the first set of cells is configured for multi-cell scheduling by the MC-DCI on the scheduling cell; and
the first USS and the second USS has a same search space identifier (ID).

14. The method of claim 12, wherein:
candidates are counted on the scheduled cell based on candidates in the first USS and candidates in the second USS.

15. The method of claim 14, wherein:
candidates of an aggregation level are counted as a summation of candidates of a same aggregation level in the first USS and in the second USS; and
a CCE resource corresponding to the summation of candidates of the same aggregation level in the first USS and in the second USS is derived based on the value for the first set of cells.

16. The method of claim 14, wherein:
CCE resources corresponding to the candidates in the first USS and the candidates in the second USS are derived based on the value for the first set of cells, respectively;
candidates of an aggregation level are counted as a summation of candidates of a same aggregation level in the first USS and in the second USS; and
in response to any two candidates in the first USS and the second USS overlapping with each other, only one of the two candidates is counted.

17. The method of claim 14, wherein:
the candidates in the first USS and the candidates in the second USS are both counted on the scheduled cell;
a CCE resource corresponding to the candidates in the first USS is derived based on a first value for the scheduling cell; and
the CCE resource corresponding to the candidates in the second USS is derived based on the value for the first set of cells.

18. The method of claim 14, wherein:
the candidates in the first USS are counted on the scheduling cell;
the candidates in the second USS are counted on the scheduled cell;
a CCE resource corresponding to the candidates in the first USS is derived based on a first value for the scheduling cell; and
a CCE resource corresponding to the candidates in the second USS is derived based on the value for the first set of cells.

19. A wireless communications apparatus comprising one or more processors and a memory, wherein the one or more processors are configured to read code from the memory and implement a method comprising:
receiving a configuration including a value for a first set of cells, a first user-specific search space (USS) of a multi-cell scheduling downlink control information (MC-DCI) on a scheduling cell, and a second USS on a scheduled cell associated with the first USS; and
determining resources of the first USS and the second USS on the scheduling cell.

20. The wireless communication apparatus of claim 19, wherein
the first set of cells comprises the scheduled cell;
the first set of cells is configured for multi-cell scheduling by the MC-DCI on the scheduling cell; and
the first USS and the second USS has a same search space identifier (ID).
